(19) United States
(12) Patent Application Publication
(10) Pub. No.: US 2026/0358562 A1
(43) Pub. Date: Nov. 12, 2026

(54) Optical Communication Switch for Preventing Crosstalk Between Non-Selected Channels

(71) Applicant: II-VI Photonics, Inc., Fuzhou (CN)

(72) Inventors: Tianguo Bai, Fuzhou (CN); Yang Li, Fuzhou (CN); Lixun Chen, Fuzhou (CN)

(21) Appl. No.: 19/430,953

(22) Filed: Dec. 23, 2025

Related U.S. Application Data
(60) Provisional application No. 63/800,574, filed on May 6, 2025.

(51) Int. Cl. G02B 6/35

(52) U.S. Cl. CPC G02B 6/3518; G02B 6/3546

(57) ABSTRACT

An optical communications switch may include a first plurality of optical fibers formed as a bundle that includes a second plurality of optical fibers which is a subset of optical fibers of the first plurality of optical fibers, each of the second plurality of optical fibers having a first diameter, and an additional optical fiber having a second diameter that is less than the first diameter of the subset of optical fibers, where the additional optical fiber is positioned an offset distance from a center of the second plurality of optical fibers.

### CROSS REFERENCE TO RELATED APPLICATION

This application claims priority to U.S. Provisional Patent Application No. 63/800,574, filed May 6, 2025, the disclosure of which is hereby incorporated by reference in its entirety.

### BACKGROUND

### 1. Field

This disclosed subject matter relates generally to devices used in fiber-optic communication and, in some non-limiting embodiments, to an optical communications switch for preventing crosstalk between non-selected channels during communication.

### 2. Technical Considerations

Optical communication (e.g., optical telecommunication) may refer to a method of communication between two locations at a distance apart using light to carry information. An optical communication system may use a transmitter, which encodes a message into an optical signal, a channel, which carries the optical signal to its destination, and a receiver, which reproduces the message from the optical signal that is received by the receiver.

Fiber-optic communication may refer to a form of optical communication that involves transmitting information from one place to another by sending pulses of light (e.g., infrared light) through an optical fiber. The light may be used as a form of carrier wave that is modulated to carry the information. Optical fiber may be preferred over electrical cabling in specific situations, such as when high bandwidth, long distance, and/or immunity to electromagnetic interference is required. Fiber-optic communication can transmit voice, video, and telemetry through local area networks or across long distances.

An optical switch may include a switch that can selectively change signals between optical fibers or integrated optical circuits in an optical communication network. A particular type of optical switch, a Micro-Electro-Mechanical Systems (MEMS) optical switch, may include a switch device that uses micro-scale mechanical elements to control and redirect optical signals, which offers advantages including fast switching speeds and small form factors, making it suitable for various applications.

However, while the MEMS optical switch is designed with two or more channels as input channels, and transmission of light during optical communication is carried out between a selected channel and a common port, crosstalk may exist between non-selected channels due to the existence of geometry symmetry in an optical fiber bundle of the MEMS optical switch.

### SUMMARY

Accordingly, it is an object of the presently disclosed subject matter to provide an optical communications switch for preventing crosstalk between non-selected channels during communication that overcomes some or all of the deficiencies of the prior art.

In some non-limiting embodiments, a Micro-Electro-Mechanical Systems (MEMS) optical switch may include a first plurality of optical fibers formed as a bundle that includes: a second plurality of optical fibers which is a subset of optical fibers of the first plurality of optical fibers, each of the second plurality of optical fibers having a first diameter; and an additional optical fiber having a second diameter that is less than the first diameter of the subset of optical fibers; where the additional optical fiber is positioned an offset distance from a center of the second plurality of optical fibers.

In some non-limiting embodiments, a Micro-Electro-Mechanical Systems (MEMS) optical switch may include: a housing; a MEMS mirror positioned within the housing; a first plurality of optical fibers formed as a bundle positioned within the housing and configured to receive an optical signal from the MEMS mirror, the first plurality of optical fibers may include: a second plurality of optical fibers that is a subset of optical fibers of the first plurality of optical fibers, each of the second plurality of optical fibers having a first diameter; and an additional optical fiber having a second diameter that is less than the first diameter of the subset of optical fibers; where the additional optical fiber is positioned an offset distance from a center of the second plurality of optical fibers.

In some non-limiting embodiments, a MEMS optical switch may include: a housing; a MEMS mirror positioned within the housing; and a first plurality of optical fibers formed as a bundle positioned within the housing and configured to receive an optical signal from the MEMS mirror, the first plurality of optical fibers may include: a second plurality of optical fibers that is a subset of optical fibers of the first plurality of optical fibers, each of the second plurality of optical fibers having a first diameter; and an additional optical fiber having a second diameter that is less than the first diameter of the subset of optical fibers; and where the additional optical fiber is positioned within the bundle between two optical fibers of the first plurality of optical fibers; wherein the additional optical fiber is positioned an offset distance from a center of the second plurality of optical fibers.

Further non-limiting embodiments or aspects will be set forth in the following numbered clauses:

Clause 1: An optical communications switch, comprising: a Micro-Electro-Mechanical Systems (MEMS) optical switch comprising: a first plurality of optical fibers formed as a bundle comprising: a second plurality of optical fibers which is a subset of optical fibers of the first plurality of optical fibers, each of the second plurality of optical fibers having a first diameter; and an additional optical fiber having a second diameter that is less than the first diameter of the subset of optical fibers; wherein the additional optical fiber is positioned an offset distance from a center of the second plurality of optical fibers.

Clause 2: The optical communications switch of clause 1, wherein the additional optical fiber is spatially matched with at least one optical fiber of the second plurality of optical fibers.

Clause 3: The optical communications switch of clause 1 or 2, wherein the additional optical fiber comprises an etched optical fiber.

Clause 4: The optical communications switch of any of clauses 1-3, wherein the additional optical fiber is secured within the bundle of the first plurality of optical fibers via an adhesive.

Clause 5: The optical communications switch of any of clauses 1-4, wherein the additional optical fiber is configured to function as a common port of the MEMS optical switch.

Clause 6: The optical communications switch of any of clauses 1-5, wherein the MEMS optical switch comprises a MEMS mirror to provide a received optical signal from a selected channel represented by an optical fiber of the second plurality of optical fibers to the additional optical fiber, and wherein the additional optical fiber is positioned within the bundle of the first plurality of optical fibers to prevent crosstalk between non-selected channels of the MEMS optical switch.

Clause 7: The optical communications switch of any of clauses 1-6, wherein the second diameter of the additional optical fiber is within a range of 10 μm to 70 μm.

Clause 8: The optical communications switch of any of clauses 1-7, wherein the first diameter of the second plurality of optical fibers is within a range of 75 μm to 150 μm.

Clause 9: The optical communications switch of any of clauses 1-8, wherein the first plurality of optical fibers comprises a common port optical fiber positioned within the second plurality of optical fibers, and wherein the additional optical fiber is positioned adjacent the common port optical fiber.

Clause 10: The optical communications switch of any of clauses 1-9, wherein the second diameter of the additional optical fiber is less than a diameter of the common port optical fiber.

Clause 11: A Micro-Electro-Mechanical Systems (MEMS) optical switch comprising: a housing; a MEMS mirror positioned within the housing; a first plurality of optical fibers formed as a bundle positioned within the housing and configured to receive an optical signal from the MEMS mirror, the first plurality of optical fibers comprising: a second plurality of optical fibers that is a subset of optical fibers of the first plurality of optical fibers, each of the second plurality of optical fibers having a first diameter; and an additional optical fiber having a second diameter that is less than the first diameter of the subset of optical fibers; wherein the additional optical fiber is positioned an offset distance from a center of the second plurality of optical fibers.

Clause 12: The MEMS optical switch of clause 11, wherein the MEMS mirror is configured to provide the optical signal from a selected channel represented by an optical fiber of the second plurality of optical fibers to the additional optical fiber, and wherein the additional optical fiber is positioned within the bundle of the first plurality of optical fibers to prevent crosstalk between non-selected channels of the MEMS optical switch.

Clause 13: The MEMS optical switch of clause 11, wherein the first plurality of optical fibers comprises a common port optical fiber positioned within the second plurality of optical fibers, and wherein the additional optical fiber is positioned adjacent the common port optical fiber.

Clause 14: The MEMS optical switch of clause 13, wherein the second diameter of the additional optical fiber is less than a diameter of the common port optical fiber.

Clause 15: The MEMS optical switch of clause 11, wherein the additional optical fiber is spatially matched with at least one optical fiber of the second plurality of optical fibers.

Clause 16: The MEMS optical switch of clause 11, wherein the additional optical fiber comprises a degraded optical fiber.

Clause 17: The MEMS optical switch of clause 11, wherein the additional optical fiber is secured within the bundle of the first plurality of optical fibers via an adhesive.

Clause 18: The MEMS optical switch of clause 11, wherein the additional optical fiber is configured to function as a common port of the MEMS optical switch.

Clause 19: A Micro-Electro-Mechanical Systems (MEMS) optical switch comprising: a housing; a MEMS mirror positioned within the housing; and a first plurality of optical fibers formed as a bundle positioned within the housing and configured to receive an optical signal from the MEMS mirror, the first plurality of optical fibers comprising: a second plurality of optical fibers that is a subset of optical fibers of the first plurality of optical fibers, each of the second plurality of optical fibers having a first diameter; and an additional optical fiber having a second diameter that is less than the first diameter of the subset of optical fibers; wherein the additional optical fiber is positioned within the bundle between two optical fibers of the first plurality of optical fibers; and wherein the additional optical fiber is positioned an offset distance from a center of the second plurality of optical fibers.

Clause 20: The MEMS optical switch of clause 19, wherein the additional optical fiber is configured to fit within an open space that is between adjacent optical fibers of the second plurality of optical fibers.

These and other features and characteristics of the presently disclosed subject matter, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter. As used in the specification and the claims, the singular forms of “a,” “an,” and “the” include plural referents unless the context clearly dictates otherwise.

### BRIEF DESCRIPTION OF THE DRAWINGS

Additional advantages and details of the disclosed subject matter are explained in greater detail below with reference to the exemplary embodiments that are illustrated in the accompanying figures, in which:

FIG. 1 is a diagram of a non-limiting embodiment of an optical communications switch for preventing crosstalk between non-selected channels during communication;

FIG. 2A is a diagram of a non-limiting embodiment of an optical fiber head array of the optical communications switch shown in FIG. 1;

FIG. 2B is a diagram of a non-limiting embodiment of a plurality of optical fibers of the optical communications switch shown in FIG. 1; and

FIGS. 3A and 3B are diagrams of an overview of an example implementation, described herein.

### DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosed subject matter as it is oriented in the drawing figures. However, it is to be understood that the disclosed subject matter may assume various alternative variations and step sequences, except where expressly specified to the contrary. It is also to be understood that the specific devices and processes illustrated in the attached drawings, and described in the following specification, are simply exemplary embodiments of the disclosed subject matter. Hence, specific dimensions and other physical characteristics related to the embodiments disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

In some non-limiting embodiments, an optical communications switch, which may include a Micro-Electro-Mechanical Systems (MEMS) optical switch, includes a first plurality of optical fibers formed as a bundle, the first plurality of optical fibers including a subset of optical fibers of the first plurality of optical fibers each having a first diameter and an additional optical fiber having a second diameter that is less than the first diameter of the subset of optical fibers, where the subset of optical fibers includes a second plurality of optical fibers. In some non-limiting embodiments, the additional optical fiber is positioned an offset distance from a center of the second plurality of optical fibers. In some non-limiting embodiments, the second diameter of the additional optical fiber is within a range of 10 μm to 70 μm. In some non-limiting embodiments, the first diameter of the first plurality of optical fibers is within a range of 75 μm to 150 μm. In some non-limiting embodiments, the additional optical fiber is spatially matched with at least one optical fiber of the second plurality of optical fibers. In some non-limiting embodiments, an optical fiber is spatially matched with another optical fiber when the mode field diameter (MFD) and/or spatial mode distribution of the optical fiber closely matches that of the other optical fiber that the initial optical fiber is being connected to. Spatial matching minimizes losses and reflections when light transitions between optical fibers and/or between an optical fiber and another component.

In some non-limiting embodiments, the additional optical fiber comprises an etched optical fiber. In some non-limiting embodiments, the additional optical fiber is secured within the bundle of the second plurality of optical fibers via an adhesive. In some non-limiting embodiments, the additional optical fiber is configured to function as a common port of the MEMS optical switch.

In some non-limiting embodiments, the first plurality of optical fibers includes a common port optical fiber positioned within the second plurality of optical fibers, where the additional optical fiber is positioned adjacent the common port optical fiber. In some non-limiting embodiments, the second diameter of the additional optical fiber is equal to a diameter of the common port optical fiber.

In some non-limiting embodiments, the MEMS optical switch includes a MEMS mirror to provide a received optical signal from a selected channel represented by an optical fiber of the second plurality of optical fibers and transmit the received optical signal to the additional optical fiber, which is positioned within the bundle of the first plurality of optical fibers to prevent crosstalk between non-selected channels of the MEMS optical switch.

In this way, based on the use of the additional optical fiber in the first plurality of optical fibers to break a symmetric layout of the optical fibers, the optical communications switch may avoid crosstalk in unselected channels in the optical communications switch.

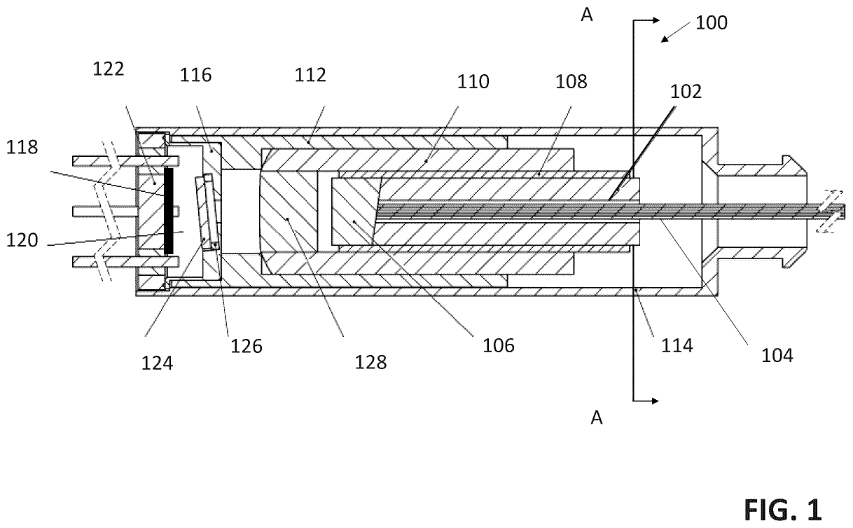

Referring now to FIG. 1, FIG. 1 is a diagram of a cross section of a non-limiting embodiment of optical communications switch 100, which may include a Micro-Electro-Mechanical Systems (MEMS) optical switch. As shown in FIG. 1, optical communications switch 100 may include optical fiber head array 102, which includes a plurality of optical fibers 104 (e.g., a first plurality of optical fibers 104) positioned adjacent (e.g., next to) glass rod 106. As further shown in FIG. 1, glass rod 106 is positioned within interior primary housing 108, which is positioned within exterior primary housing 110. In some non-limiting embodiments, interior primary housing 108 and/or exterior primary housing 110 may be made of a material that does not interfere with optical light beams that pass through optical communications switch 100, such as glass. As further shown in FIG. 1, exterior primary housing 110 may be positioned within interior secondary housing 112, which is positioned within exterior secondary housing 114. In some non-limiting embodiments, interior secondary housing 112 and/or exterior secondary housing 114 may be made of a material that provides structural protection to components of optical communications switch 100, such as metal, fiberglass, plastic, and/or the like.

As further shown in FIG. 1, optical communications switch 100 may include cap component 116 and MEMS device 118. In some non-limiting embodiments, MEMS device 118 may include one or more devices to physically direct (e.g., redirect) optical light beams along a desired path. For example, MEMS device 118 may include a plurality of mirrors (e.g., an array of mirrors) that may be movable based on control signals from a controller (e.g., a processor, a microprocessor, a microcontroller, etc.). In some non-limiting embodiments, the plurality of mirrors of MEMS device 118 may be referred to as a MEMS mirror. In some non-limiting embodiments, the plurality of mirrors of MEMS device 118 may have a size (e.g., a length and/or a width) in a range of 10 μm to 2 mm. In a specific example, the mirrors of MEMS device 118 may have a size in a range of 10 μm to 200 μm. In another specific example, the mirrors of MEMS device 118 may have a size in a range of 200 μm to 1 mm. In some non-limiting embodiments, MEMS device 118 may include a 2D MEMS device or a 3D MEMS device.

Additionally shown in FIG. 1, MEMS device 118 may be positioned within hermetically sealed chamber 120 of cap component 116 and may be supported by base section 122. Cap component 116 may be configured to shield MEMS device 118. As further shown in FIG. 1, cap component 116 may include window 124 that is held in place within cap component 116 via glass solder 126. In some non-limiting embodiments, cap component 116 may be bonded to MEMS device 118 during a batch process. In some non-limiting embodiments, cap component 116 may be bonded to MEMS device 118 via anodic bonding, glass frit bonding (e.g., via glass solder 126), and/or metal seal bonding.

In addition, cylindrical lens (C-lens) 128 may be positioned within exterior primary housing 110 between window 124 and an end of glass rod 106 that is adjacent optical fiber head array 102. In some non-limiting embodiments, C-lens 128 may focus an optical light beam (e.g., along a single axis), which helps to efficiently couple light between the plurality of optical fibers 104 and MEMS device 118.

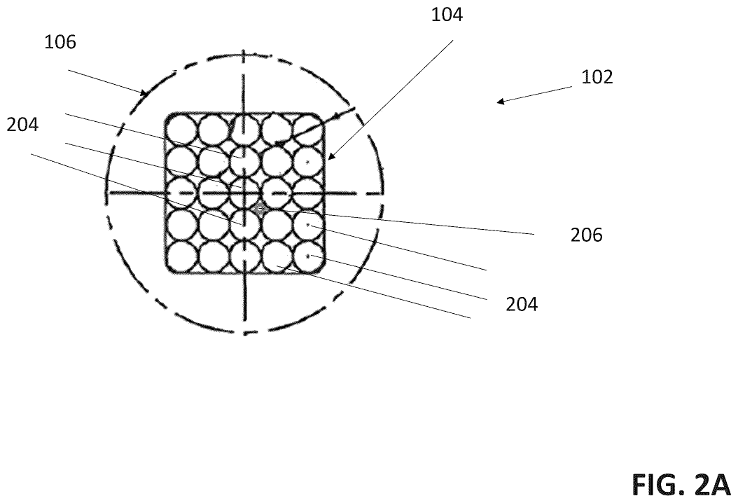

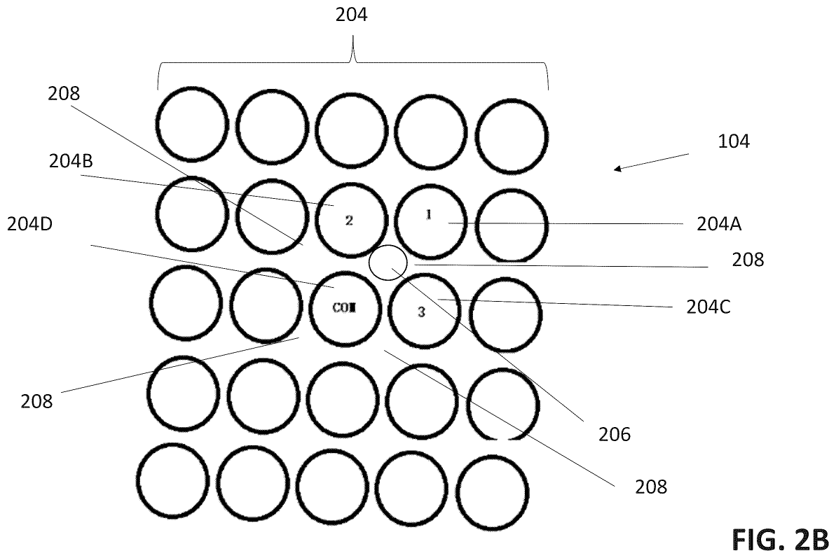

Referring now to FIG. 2A, FIG. 2A is a diagram of a cross section along line A-A of a non-limiting embodiment of optical fiber head array 102 of optical communications switch 100. As shown in FIG. 2A, the plurality of optical fibers 104 are positioned adjacent glass rod 106. In some non-limiting embodiments, the plurality of optical fibers 104 may be formed as a bundle (e.g., as an NxN or as an MxN structure fiber bundle). In one example, the plurality of optical fibers 104 may include 25 optical fibers formed as a bundle. In other examples, the plurality of optical fibers 104 may include an odd (e.g., 35, 45, 55, 65, etc.) or even number of optical fibers (e.g., 30, 40, 50, 60, etc.) formed as a bundle. In some non-limiting embodiments, the plurality of optical fibers 104 (e.g., a first plurality of optical fibers 104) may include a subset of optical fibers 204 (e.g., a second plurality of optical fibers 204) and additional optical fiber 206. Each optical fiber 204 of the subset of optical fibers 204 may have a first diameter and additional optical fiber 206 may have a second diameter, where the first diameter and the second diameter are different and the first diameter is larger than the second diameter (e.g., the second diameter is less than the first diameter). In some examples, the first diameter (e.g., a diameter of an optical fiber including core and cladding) may be in a range of 75 μm to 150 μm. In one example, the first diameter may be equal to 125 μm. In some examples, the second diameter (e.g., a diameter of an optical fiber including core and cladding) may be in a range of 10 μm to 70 μm. In one example, the second diameter may be equal to 50 μm. In another example, the second diameter may be equal to 68 μm.

As further shown in FIG. 2A, additional optical fiber 206 is positioned an offset distance from a center of the subset of optical fibers 204. Additionally or alternatively, additional optical fiber 206 may be positioned within the bundle of the plurality of optical fibers 104 between two optical fibers 204 of the subset of optical fibers 204.

In some non-limiting embodiments, additional optical fiber 206 may be spatially matched with at least one optical fiber 204 of the subset of optical fibers 204. For example, additional optical fiber 206 may be positioned in an open space (e.g., a void, a free space, etc.) between two optical fibers 204 of the subset of optical fibers 204. In some non-limiting embodiments, additional optical fiber 206 may include an etched optical fiber. For example, additional optical fiber 206 may include a chemically etched optical fiber. In some non-limiting embodiments, additional optical fiber 206 may include a small cladding optical fiber (e.g., an optical fiber with a cladding diameter in a range of 50μm to 80μm and a core diameter in a range of 8 μm to 10 μm).

In some non-limiting embodiments, additional optical fiber 206 may include a degraded optical fiber that has been subject to a degradation process. In some non-limiting embodiments, the degradation process may include a chemical exposure procedure performed on the optical fiber, an ultraviolet light and/or radiation exposure procedure, and/or a mechanical stress exposure procedure. In some non-limiting embodiments, additional optical fiber 206 may be secured within the bundle of the plurality of optical fibers 104 via an adhesive.

In some non-limiting embodiments, the MEMS mirror of MEMS device 118 may be configured to provide a received optical signal from a selected channel represented by optical fiber 204 of the subset of optical fibers 204, and transmit the received optical signal to additional optical fiber 206, which may be positioned within the bundle of the plurality of optical fibers 104 (e.g., be positioned within the bundle of the plurality of optical fibers 104 to break a symmetric layout of optical fibers 104) to prevent crosstalk of optical signals between (e.g., prevent transmission of the received optical signal to) non-selected channels of optical communications switch 100 (e.g., of the MEMS optical switch of optical communications switch 100).

Referring now to FIG. 2B, FIG. 2B is a diagram of a non-limiting embodiment of the plurality of optical fibers 104 shown in FIGS. 1 and 2B. As shown in FIG. 2B, the plurality of optical fibers 104 includes the subset of optical fibers 204 and additional optical fiber 206. As further shown in FIG. 2B, the subset of optical fibers 204 may include first optical fiber 204A, second optical fiber 204B, third optical fiber 204C, and fourth optical fiber 204D. First optical fiber 204A, second optical fiber 204B, and third optical fiber 204C may each represent a channel (e.g., a path for an optical light beam for communication purposes) of optical communications switch 100. For example, first optical fiber 204A, second optical fiber 204B, and third optical fiber 204C may represent a first channel, a second channel, and a third channel, respectively. Fourth optical fiber 204D may be a common port optical fiber of the plurality of optical fibers 104. As further shown in FIG. 2B, additional optical fiber 206 is positioned adjacent to fourth optical fiber 204D and in an open space formed between first optical fiber 204A, second optical fiber 204B, third optical fiber 204C, and fourth optical fiber 204D. In some non-limiting embodiments, additional optical fiber 206 may be positioned adjacent to fourth optical fiber 204D and in any of the open spaces created between fourth optical fiber 204D and the optical fibers that immediately surround (e.g., the optical fibers that surround and may be in contact with fourth optical fiber 204D, the optical fibers that surround and may be within a distance that is less than a diameter of an optical fiber, etc.) fourth optical fiber 204D. With this, additional optical fiber 206 may be configured to function as a common port of optical communications switch 100 (e.g., the MEMS optical switch of optical communications switch 100). In this way, additional optical fiber 206 may replace fourth optical fiber 204D as the common port of optical communications switch 100.

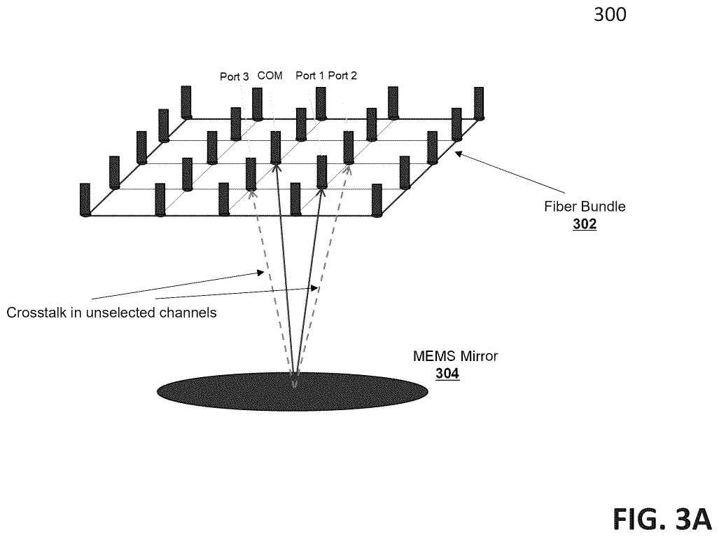

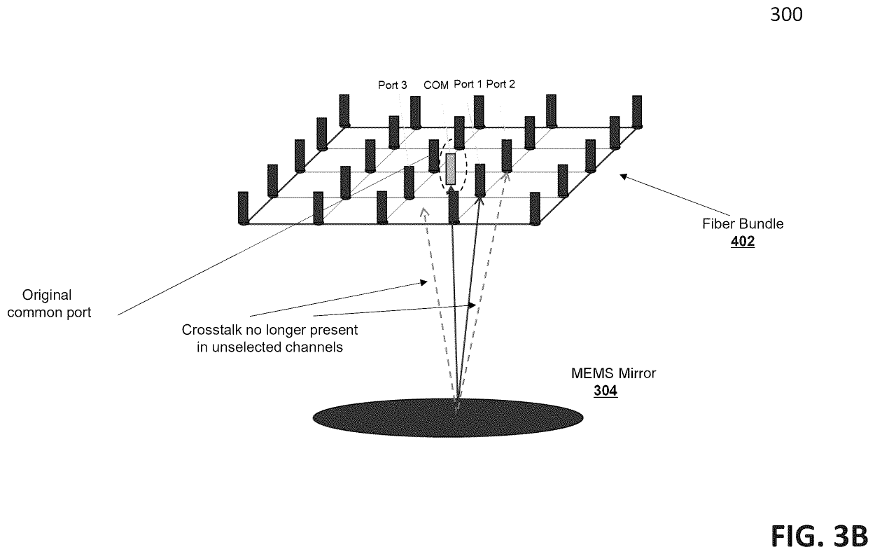

Referring now to FIGS. 3A and 3B, FIGS. 3A and 3B are diagrams of an overview of example implementation 300, described herein. FIG. 3A shows fiber bundle 302 and MEMS mirror 304, which may be components of an optical communication switch (e.g., optical communications switch 100). Fiber bundle 302 may include an optical fiber array that includes a plurality of optical fibers each having a diameter that is the same and are positioned to have a symmetrical cross section about a central optical fiber that is configured as a common port (e.g., shown as “COM” in FIG. 3A) of fiber bundle 302. Additionally, fiber bundle 302 includes an optical fiber associated with a first channel (e.g., shown as “port 1” in FIG. 3A), an optical fiber associated with a second channel (e.g., shown as “port 2” in FIG. 3A), and an optical fiber associated with a third channel (e.g., shown as “port 3” in FIG. 3A).

When an optical light beam is desired to be transmitted from port 1 to COM port via MEMS mirror 304, port 1 is a selected channel, and port 2 and port 3 (e.g., and other ports) are non-selected. In a state where port 1 and COM port are connected, port 2 and port 3 are connected, the optical light beam from port 2 goes to port 3 and light from port 3 goes to port 2, which will cause signal crosstalk between port 2 and port 3 based on the law of reflection and symmetry of the optical fiber array.

FIG. 3B shows fiber bundle 402 and MEMS mirror 304, which may be components of an optical communication switch (e.g., optical communications switch 100). Fiber bundle 402 may include an optical fiber array that includes a plurality of optical fibers which may be the same as or similar to the plurality of optical fibers 104. As shown in FIG. 3B, fiber bundle 402 may include an additional optical fiber (e.g., additional optical fiber 206) that is positioned an offset distance from a center of a second plurality of optical fibers, which includes an optical fiber associated with a first channel (e.g., shown as “port 1” in FIG. 3B), an optical fiber associated with a second channel (e.g., shown as “port 2” in FIG. 3B), and an optical fiber associated with a third channel (e.g., shown as “port 3” in FIG. 3B). Additional optical fiber 206 is configured to function as the common port and replace the optical fiber that functioned as the original common port.

When an optical light beam is desired to be transmitted from port 1 to COM port via MEMS mirror 304, and port 1 is a selected channel and port 2 and port 3 (e.g., and other ports) are non-selected, because the symmetry structure of the optical fiber array is broken by inserting the additional optical fiber as the common port (e.g., shown as “COM” in FIG. 3B) beside the central optical fiber (e.g., the original common port), port 2 and port 3 are not connected. Accordingly, any issues of signal crosstalk are resolved between non-selected channels.

What is claimed is:

1. An optical communications switch, comprising:
a Micro-Electro-Mechanical Systems (MEMS) optical switch comprising:
a first plurality of optical fibers formed as a bundle comprising:
a second plurality of optical fibers which is a subset of optical fibers of the first plurality of optical fibers, each of the second plurality of optical fibers having a first diameter; and
an additional optical fiber having a second diameter that is less than the first diameter of the subset of optical fibers;
wherein the additional optical fiber is positioned an offset distance from a center of the second plurality of optical fibers.

2. The optical communications switch of claim 1, wherein the additional optical fiber is spatially matched with at least one optical fiber of the second plurality of optical fibers.

3. The optical communications switch of claim 1, wherein the additional optical fiber comprises an etched optical fiber.

4. The optical communications switch of claim 1, wherein the additional optical fiber is secured within the bundle of the first plurality of optical fibers via an adhesive.

5. The optical communications switch of claim 1, wherein the additional optical fiber is configured to function as a common port of the MEMS optical switch.

6. The optical communications switch of claim 1, wherein the MEMS optical switch comprises a MEMS mirror to provide a received optical signal from a selected channel represented by an optical fiber of the second plurality of optical fibers to the additional optical fiber, and wherein the additional optical fiber is positioned within the bundle of the first plurality of optical fibers to prevent crosstalk between non-selected channels of the MEMS optical switch.

7. The optical communications switch of claim 1, wherein the second diameter of the additional optical fiber is within a range of 10 μm to 70 μm.

8. The optical communications switch of claim 1, wherein the first diameter of the second plurality of optical fibers is within a range of 75 μm to 150 μm.

9. The optical communications switch of claim 1, wherein the first plurality of optical fibers comprises a common port optical fiber positioned within the second plurality of optical fibers, and wherein the additional optical fiber is positioned adjacent the common port optical fiber.

10. The optical communications switch of claim 9, wherein the second diameter of the additional optical fiber is less than a diameter of the common port optical fiber.

11. A Micro-Electro-Mechanical Systems (MEMS) optical switch comprising:
a housing;
a MEMS mirror positioned within the housing;
a first plurality of optical fibers formed as a bundle positioned within the housing and configured to receive an optical signal from the MEMS mirror, the first plurality of optical fibers comprising:
a second plurality of optical fibers that is a subset of optical fibers of the first plurality of optical fibers, each of the second plurality of optical fibers having a first diameter; and
an additional optical fiber having a second diameter that is less than the first diameter of the subset of optical fibers;
wherein the additional optical fiber is positioned an offset distance from a center of the second plurality of optical fibers.

12. The MEMS optical switch of claim 11, wherein the MEMS mirror is configured to provide the optical signal from a selected channel represented by an optical fiber of the second plurality of optical fibers to the additional optical fiber, and wherein the additional optical fiber is positioned within the bundle of the first plurality of optical fibers to prevent crosstalk between non-selected channels of the MEMS optical switch.

13. The MEMS optical switch of claim 11, wherein the first plurality of optical fibers comprises a common port optical fiber positioned within the second plurality of optical fibers, and wherein the additional optical fiber is positioned adjacent the common port optical fiber.

14. The MEMS optical switch of claim 13, wherein the second diameter of the additional optical fiber is less than a diameter of the common port optical fiber.

15. The MEMS optical switch of claim 11, wherein the additional optical fiber is spatially matched with at least one optical fiber of the second plurality of optical fibers.

16. The MEMS optical switch of claim 11, wherein the additional optical fiber comprises a degraded optical fiber.

17. The MEMS optical switch of claim 11, wherein the additional optical fiber is secured within the bundle of the first plurality of optical fibers via an adhesive.

18. The MEMS optical switch of claim 11, wherein the additional optical fiber is configured to function as a common port of the MEMS optical switch.

19. A Micro-Electro-Mechanical Systems (MEMS) optical switch comprising:
a housing;
a MEMS mirror positioned within the housing; and
a first plurality of optical fibers formed as a bundle positioned within the housing and configured to receive an optical signal from the MEMS mirror, the first plurality of optical fibers comprising:
a second plurality of optical fibers that is a subset of optical fibers of the first plurality of optical fibers, each of the second plurality of optical fibers having a first diameter; and
an additional optical fiber having a second diameter that is less than the first diameter of the subset of optical fibers;
wherein the additional optical fiber is positioned within the bundle between two optical fibers of the first plurality of optical fibers; and
wherein the additional optical fiber is positioned an offset distance from a center of the second plurality of optical fibers.

20. The MEMS optical switch of claim 19, wherein the additional optical fiber is configured to fit within an open space that is between adjacent optical fibers of the second plurality of optical fibers.
